(19) United States
(12) Patent Application Publication
(10) Pub. No.: US 2005/0081917 A1
(43) Pub. Date: Apr. 21, 2005

(54) Performance polymer film insert molding for fluid control devices

(76) Inventors: Sanjiv M. Bhatt, Minnetonka, MN (US); Shawn D. Eggum, Lonsdale, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/496,699

(22) PCT Filed: Nov. 26, 2002
(86) PCT No.: PCT/US02/37966

Related U.S. Application Data
(60) Provisional application No. 60/333,685, filed on Nov. 27, 2001.

(51) Int. Cl. F16K 25/00

(52) U.S. Cl. 137/375

(57) ABSTRACT

The present invention relates generally to a system and method for including a thin protective containment polymer film (100), such as Peek in the molding process for fluid processing devices utilized in the semiconductor processing industry. The thermoplastic film of predetermined size and shape is selectively placed along a shaping surface (110) in a mold cavity (106) for alignment with a desired target surface of a molded material. The molding processes causes a surface of the film (100) to bond to a contact surface of the moldable material such that the film (100) is permanently adhered to the moldable material. As a result, a comparable polymer film can be selectively bonded only to those target surfaces where performance characteristics such as abrasion resistance, heat resistance, chemical resistance, outgassing prevention, rigidity enhancement, fluid absorption prevention, ultraviolet resistance, friction reduction and the like is needed.

The present invention claims priority to Provisional Application No. 60/333,685, filed Nov. 27,2001, entitled PERFORMANCE POLYMER FILM INSERT MOLDING FOR FLUID CONTROL DEVICES and is incorporated by reference herein.

### FIELD OF THE INVENTION

The present invention relates generally to film insert molding, and more particularly to insert molding a thin performance polymer film during the molding of fluid control devices to provide desired performance characteristics.

### BACKGROUND OF THE INVENTION

Conventional film insert molding is commonly utilized in manufacturing processes to increase aesthetic appeal in various consumer products. Namely, decorative decals, instructions, logos, and other visual graphics are printed on one surface of a thin transparent polymer film for use in the insert molding process. Later developments expanded the use of the film to permanently fix functional features such as barcodes to the products. In both circumstances, the film is placed into a portion of the mold cavity prior to the injection of a moldable material. This creates a bond between the film and the molded part such that inexpensive decoration or indicia can be selectively placed on the part, while at the same time simplifying the use of indicia around complicated contours and in difficult-to-reach locations. Similarly, such film insert molding and/or decorative molding simplifies the manufacturing process by eliminating the need to have the indicia etched or shaped into the actual surface of the mold itself. This increases design and manufacturing flexibility, and the level of detail that can be included in the final product.

The semi-conductor industry introduces unique and unconventional purity and anti-contamination requirements into the development and implementation of product designs and manufacturing processes. Most importantly, material selection is essential in the fluid control devices used in semiconductor processing. Flowmeters, valves, tubing, connectors and other devices are regularly implemented in such processing. In semiconductor processing, highly corrosive, ultra-pure fluids, such as hydrochloric, sulfuric and hydrofluoric acid, are utilized. Often these fluid are used at extreme temperature ranges. These fluids not only damage traditional devices, but they additionally impose significant health risks for personnel exposed to the fluids during the manufacturing process. Moreover, the equipment and materials in contact with these ultra-pure fluids must not contaminate or add impurities to the fluids.

Thus, semiconductor processing applications require device construction utilizing highly inert materials that withstand the potential damaging effects of these corrosive fluids, that do not contaminate the fluids, and that tolerate the broad temperature ranges. Moreover, the design of such devices must minimize fluid leakage pathways. Various thermosplastic polymers such as Polyethylene (PE), Perflueroalkoxy (PFA), Polycarbonates (PC), Polytetrafluoroethylenes (PTFE), Polyetheretherketone (PEEK), and the like are generally utilized.

One of the major advantages of these particular thermoplastic polymers, such as PEEK, is their abrasion resistant qualities. Typical inexpensive conventional plastics release tiny particles into the air when abraded. While these particles are typically invisible to the naked eye, they result in the introduction of potentially damaging contaminants into the environment, or the processing fluid. A major benefit of some of these specialized thermoplastic polymers is their abrasion-resistant qualities. However, specialized thermoplastic polymers are often dramatically more expensive than conventional polymers.

Currently, a manufacturer of these fluid control devices is forced to make a decision between contamination and cost. While increased protection may be only needed at limited contact points or surfaces, the entire device, or a substantial portion thereof, must be constructed of the preferred polymer. For instance, it may be the case that only the inner surface of a flow meter or other processing tubing requires specific chemical-resistant, heat-resistant, or abrasion-resistant materials. Similarly, a fluid control valve may only require protection at the inner cavity of the valve and/or at the contact surface of the valve diaphragm. However, conventional systems and techniques require the manufacturer to construct the entire tubing, flow meter, or valve of the preferred material. Consequently, there is a need in the semiconductor industry to make it is possible to bond compatible performance-enhancing polymers with the existing products and materials to maximize performance of manufactured fluid control devices. More particularly, such an innovation would significantly reduce the costs of manufacturing and design by permitting selective use of particular polymers on only those targeted surfaces where it is most beneficial.

### SUMMARY OF THE INVENTION

The present invention relates generally to a system and method for including a thin protective containment thermoplastic polymer film, such as PEEK, in the molding process for manufacturing fluid control devices to increase performance characteristics of the devices, such as abrasion-resistance, and targeted protection from corrosive fluids and environmental elements. The performance polymer film of predetermined size and shape is selectively placed in a mold cavity for alignment with a desired target surface of a moldable material. The molding process causes a surface of the film to permanently bond to the target surface of the moldable material, and the resulting molded part. As a result, a compatible thermoplastic polymer film can be selectively bonded only to those target surfaces where specific performance characteristics such as abrasion resistance, heat resistance, chemical resistance, ultraviolet resistance, outgassing containment, rigidity enhancement, fluid absorption containment and the like is needed. For instance, a valve designed for use in a semiconductor processing environment could include a thermoplastic polymer film on at least a portion of its fluid connections to provide an abrasion resistant surface for interconnecting with other fluid processing components. Further, the thermoplastic polymer film could comprise a laminate including an intermediate layer to promote bonding between a thermoplastic polymer film having a desired characteristic and a conventional polymer used in molding the fluid processing device.

An object and feature of particular embodiments of the present invention is that it provides a cost-efficient means of selectively utilizing desirable polymer film such that it is not necessary to utilize more of the polymer than is required on a particular portion of a fluid control device.

Another object and feature of particular embodiments of the present invention is the selective use of preferred abrasion-resistant polymer films on fluid control devices being used in the semiconductor industry.

Yet another object and feature of particular embodiments of the present invention is that materials can be used for the film that provide desirable surface containment properties. The film can serve to prevent contamination between the fluids or the environment and a designated surface of the fluid control device.

Another object and feature of particular embodiments of the present invention is the selective use of preferred chemical-resistant polymer films with fluid control devices being used in the semi-conductor industry.

Another object and feature of particular embodiments of the present invention is the selective use of preferred low permeability polymer films with fluid control devices being used in the semi-conductor industry.

Another object and feature of particular embodiments of the present invention is the selective use of preferred ultraviolet-resistant polymer films with fluid control devices being used in the semi-conductor industry.

Another object and feature of particular embodiments of the present invention is the selective use of preferred heat-resistant polymer films with fluid control devices being used in the semi-conductor industry.

Another object and feature of particular embodiments of the present invention is the selective use of preferred low out gassing polymer films with fluid control devices being used in the semi-conductor industry.

Another object and feature of particular embodiments of the present invention is the selective use of preferred low friction polymer films with fluid control devices being used in the semi-conductor industry.

Another object and feature of particular embodiments of the present invention is the selective use of preferred clean (lack of contaminants) polymer films with fluid control devices being used in the semi-conductor industry.

Still another object and feature of particular embodiments of the present invention is forming a fluid control device with a PEEK surface area that is transparent or translucent. Such a device is formed by utilizing a thin enough layer of PEEK such that it is transparent, and then molding, with or without an intermediate layer, the primary transparent base material, such as PC.

### BRIEF DESCRIPTION OF THE DRAWINGS

FIG. 1 is a sectional view of an injection molding system

FIG. 2 is a magnified view of a section of an injection molding system including a performance film insert.

FIG. 3 is a sectional view of a performance film insert molding system in accordance with the present invention.

FIG. 4 is a sectional view of a performance film insert molding system in accordance with the present invention.

FIG. 5 is a sectional view of a two-way valve device with insert molded performance film in accordance with the present invention.

FIG. 6 is a sectional view of a three-way valve device with insert molded performance film in accordance with the present invention.

FIG. 7 is a sectional view of a length of plastic tubing with insert molded performance film in accordance with the present invention.

FIG. 8 is a sectional end view of a length of plastic tubing with insert molded performance film in accordance with the present invention.

FIG. 9 is a sectional view of a length of plastic tubing having a barbed end including insert molded performance film in accordance with the present invention.

FIG. 10 is a sectional end view of a length of plastic tubing having a barbed end including insert molded performance film in accordance with the present invention.

FIG. 11 is a sectional view of an inline flow meter with insert molded performance film in accordance with the present invention.

FIG. 12 is a sectional view of an inline flow meter sight tube with insert molded performance film in accordance with the present invention.

FIG. 13 is a sectional view of a plastic tubing connector with insert molded performance film in accordance with the present invention.

FIG. 14 is a sectional view of molding a multi-layer film in accordance with the present invention.

### DETAILED DESCRIPTION OF THE PREFERRED EMBODIMENT

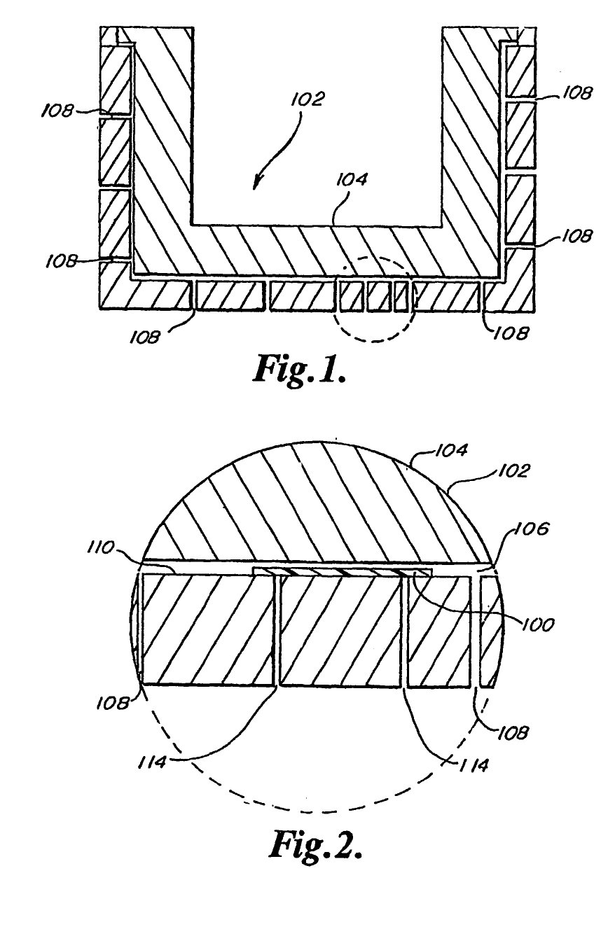

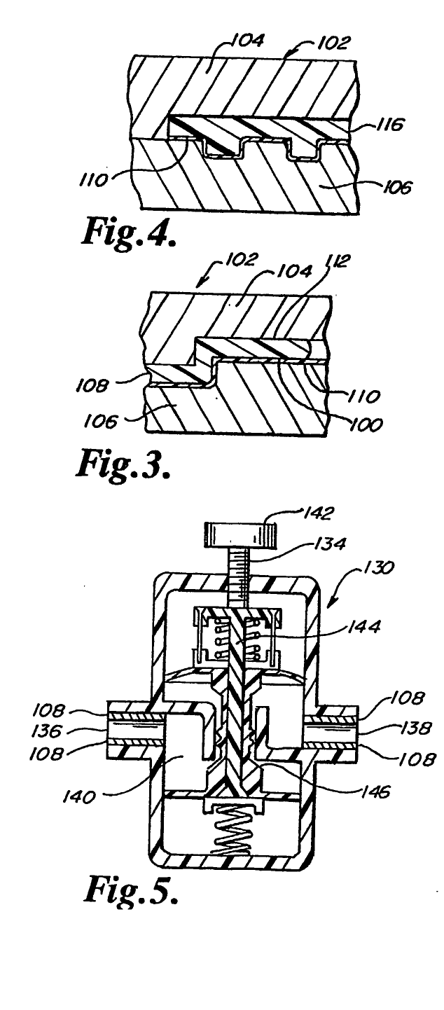

Referring to FIGS. 1, 2, 3 and 4, a system and process of insert molding a performance polymer film 100 in accordance with the present invention is shown. The polymer film 100 is at least partially defined by a limited level of thickness. For instance, a single film layer thickness equal to or less than approximately 0.040 inches (forth-thousandths) is envisioned. Preferably, the single film layer is less than or equal to approximately 0.030 inches (thirty-thousandths). Most preferably, the insert molding process is accomplished as a step in an injection molding process. As contained in FIGS. 1 and 2, an injection molding process involves a molding unit 102 having a mold cover 104, a mold cavity 106 and at least one injection channel 108. Mold cavity 106 can include a shaping surface 110, or surfaces, designed to shape the injected moldable material 112 and/or the polymer film 100 during the molding process. Mold cover 104 selectively engages or covers the mold cavity 106. Various embodiments of the molding unit 102 can further include at least one vacuum channel 114 in communication with the mold cavity 106 and/or the shaping surface 110 to introduce vacuum suction in securing an object, such as polymer film 100, to the mold cavity 106. Other known techniques for securably conforming the polymer film 100 within mold cavity 106 and shaping surface 110 employing static attraction and forceable engagement are also envisioned for use with the present invention. It should be noted that various figures depict polymer film 100 as disproportionately large in comparison to the corresponding fluid processing devices for illustrative purposes only and is not intended to represent actual proportions for the present invention.

Polymer film 100 comprises at least one protective or containment film having a functional performance characteristic. The use of a particular polymer will depend greatly on the performance characteristic being advanced or required. Typical characteristics include abrasion resistance, heat resistance, chemical resistance, ultra-violet resistance, outgasing containment, rigidity enhancement, fluid absorption containment, friction reduction and other characteristics that are of concern in semiconductor processing. Any compatible material can be utilized for the polymer film 100 to achieve these functional performance characteristics. For example, polyester, polyimide (PI), polyether imide (PEI), PEEK, perfluoroalkoxy resin (PFA), fluorinated ethylene propylene copolymer (FEP), polyvinylidene fluoride (PVDF), polymethyl methacrylate (PMMA), polyether sulfone (PES), polystyrene (PS), polyphenylene sulfide (PPS), and a myriad of other compatible polymers are available. The polymer film 100 is preferably a plastic polymer such as PFA, PC, PEEK, and PE. Additionally, other polymers such as Polyetherimide (PEI), Polytetrafluoroethylenes (PTFE), Polyethersulfone (PES), and Polysulfone (PSU) are also available as a result of their innately preferred characteristics. Polymer film 100 is precut to a predetermined shape and size depending on the surface/geometry of molding unit 102. After cutting, the polymer film 100 is then thermoformed. The polymer film 100 is generally thin and sheet-like to better facilitate moldability and to maximize the transparent characteristics of the material In addition, polymer film 100 can include multiple layers, each layer imparting differing performance or containment characteristics listed herein, or to provide a combination thereof. Of course, the implementation of laminates of multiple layers will alter the preferred thickness criteria. A myriad of film lamination techniques known to one skilled in the art are envisioned for use with the present invention. For instance, U.S. Pat. Nos. 3,660,200, 4,605,591, 5,194,327, 5,344,703, and 5,811,197 disclose thermoplastic lamination techniques and are incorporated herein by reference.

In one embodiment, mold cover 104 is removably securable to the mold cavity 106 to facilitate polymer film 100 insertion, and removal of the molded fluid processing device 116. The fluid processing device 116 can be either a substantially, complete device or a subcomponent for use in constructing a complete device. For example, fluid processing device 116 could comprise an entire valve body or a portion of a valve stem.

The injected moldable material 112 is preferably a substantially non-conductive thermoplastic material commonly used in molding parts for any fluid processing device in the semiconductor processing industry. Again, the moldable material 112 can be PFA, PE, PC and like known materials. More specifically, the moldable material 112 can be the material conventionally used to construct valves, tubing, flowmeters, connector and the like for use in semiconductor processing.

In operation, polymer film 100 is cut to a predetermined shape and then thermoformed to a required form. Following the thermoforming operation, polymer film 100 is placed into the molding unit 102 such that the polymer film 100 is in surface contact with at least a portion of the shaping surface 110. The mold cover 104 is then closed in preparation for the injection of injected moldable material 112. At this point, moldable material 112 in a substantially molten state is injected into the mold cavity 106 through the at least one injection channel 108. After waiting a requisite cooling period, the moldable material 112 cools to form the substantially solidified fluid processing device 116. The molten injection combined with the cooling process forms a permanent adhering bond between the polymer film 100 and the fluid processing device 116.

After completion of the molding process, the fluid processing device 116 can be ejected from the molding unit 102 with the fluid processing device 116 having a performance polymer film 100 permanently bonded to a desired target surface. Conventional tooling, techniques, and practices known by those skilled in the art can be used in injecting the moldable material 112 and ejecting the fluid processing device 116.

As depicted in FIG. 5, the fluid processing device 116 can be in the form of a two-position valve 130. Two-position valve 130 includes a valve body 132 and a valve stem 134. Valve body 132 includes an inlet port 136 and an outlet port 138 connected by a continuous flow channel 140. Valve stem 132 includes a handle 142, a rod 144 and a sealing face 146. Located within inlet port 136 and outlet port 138 is polymer film 100. Polymer film 100 is insert molded within inlet port 136 and outlet port 138 using the afore mentioned molding process during the molding of valve body 132. In alternative embodiments of two-position valve 130, polymer film 100 can be insert molded over the outside of inlet port 136 and outlet port 138. Polymer film 100 can also be insert molded over the entire wetted surface of two-position valve 130 including inlet port 136, outlet port 138 and flow channel 140. Polymer film 100 can also be insert molded to valve stem 134. On valve stem 134, polymer film 108 can be insert molded over rod 144 or over sealing face 146.

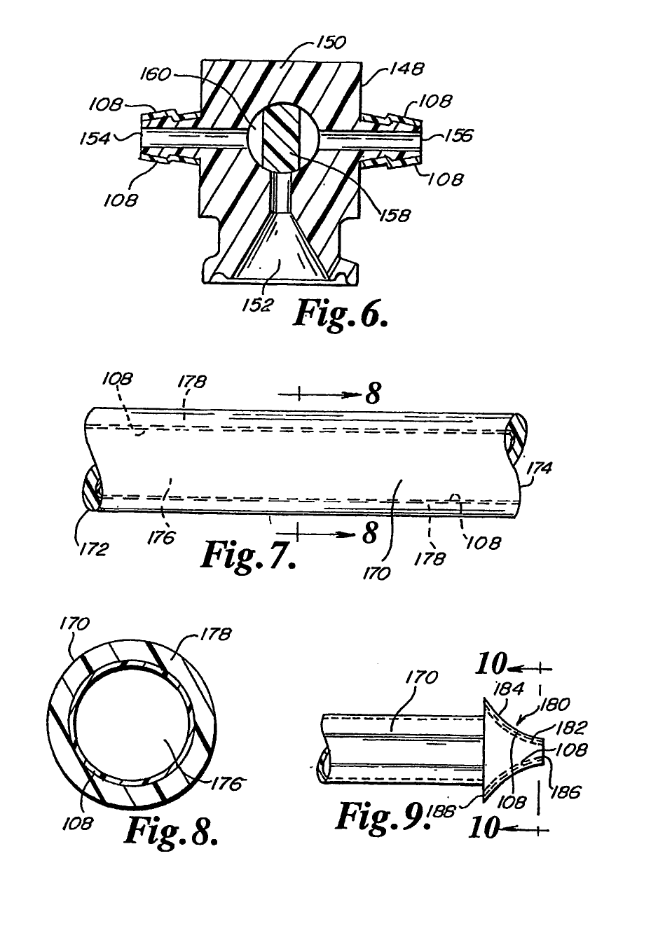

An alternative embodiment of fluid processing device 116 is depicted in FIG. 6. As will be obvious to one skilled in the art, the insert molding of polymer film 100 is equally applicable to the range of valves used in the semiconductor processing industry. In FIG. 6, a three-position valve 148 includes a valve body 150 having an inlet port 152, a first outlet port 154 and a second outlet port 156. Three-position valve 148 also includes a valve stem 158 within a central bore 160. First outlet port 154 and second outlet port 156 are configured having barbed ends facilitating interconnection to the remainder of a fluid circuit. Polymer film 100 is insert molded using the afore mentioned molding process over first outlet port 154 and second outlet port 156. In alternative embodiments, polymer film 100 can be insert molded to the interior surfaces of first outlet port 154 and second outlet port 156. In another embodiment, polymer film 100 can be insert molded to the interior surface of inlet port 152. In another embodiment, polymer film 100 can be insert molded to the interior surface of central bore 160. In another embodiment, polymer film 100 can be insert molded to valve stem 158.

With respect to FIGS. 5 and 6, it will be obvious to one skilled in the art that the insert molding of polymer film 108 can be applied to almost any valve configuration. These configurations could include any number of inlet and outlet ports, all variety of valve connections including male and female, threaded style connectors and, sanitary connectors. In addition, the insert molding process of the present invention can be selectively applied to the wide variety of valve stems including those used in ball valves, gate valves, diaphragm valves and any sealing method.

As depicted in FIG. 7, the fluid processing device 116 can be in the form of a length of plastic tubing 170. Plastic tubing 170 includes a proximal end 172 and a distal end 174. Plastic tubing 170 also includes an internal cavity 176 defined by tube wall 178. In the present embodiment, polymer film 100 has been insert molded around the exterior of tube wall 178. Polymer film 100 can run the length of plastic tubing 170 or can be positioned at either proximal end 172 or distal end 174. In an alternative embodiment shown in FIG. 8, polymer film 100 will be insert molded to the interior surface of tube wall 178.

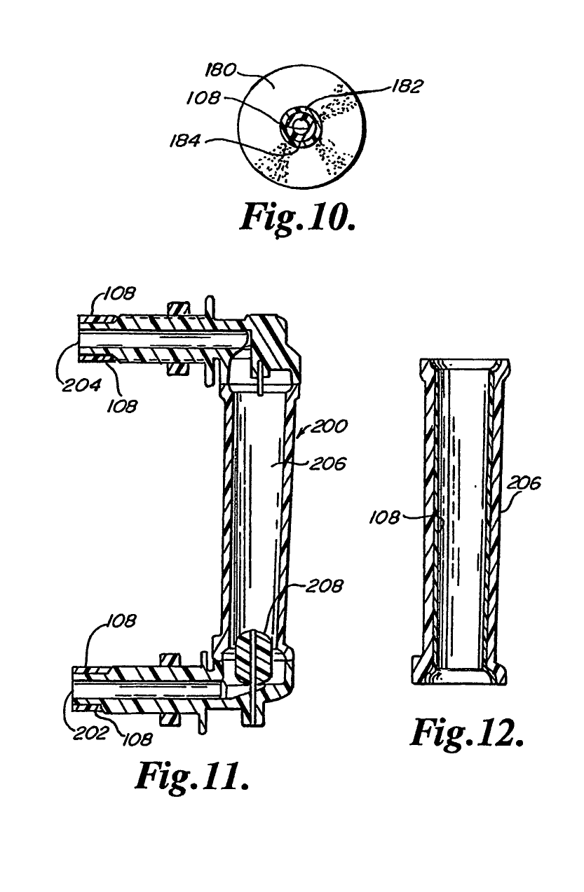

In a variation on plastic tubing 170 depicted in FIGS. 9 and 10, proximal end 172 and/or distal end 174 can be molded in the form of a barb 180. Barb 180 includes a barb wall 182 with an exterior tapered surface 184, an insertion point 186 and a protrusion 188. Barb 180 can be used to facilitate interconnection with other piping components with insertion point 186 providing a guiding mechanism and protrusion 188 providing a retention mechanism. In the present embodiment, polymer film 100 has been insert molded over tapered surface 182. In an alternative embodiment, polymer film 100 could be insert molded on the inside surface of barb wall 182. In another alternative embodiment, polymer film 100 could be insert molded over the exterior surfaces of both the barb 180 and tubing 170. In another alternative embodiment, polymer film 100 could be insert molded on the interior surface of both the barb 180 and tubing 170.

As depicted in FIG. 11, the fluid processing device 116 can be in the form of a flowmeter assembly 200. Flowmeter assembly 200 includes an inlet port 202, an outlet port 204, a sight tube 206 and a float 208. In the pictured embodiment, polymer film 100 has been inserted molded over the exterior surfaces of inlet port 202 and outlet port 204. In an alternative embodiment, polymer film 100 could be insert molded to the interior surfaces of inlet port 202 and outlet port 204. In another alternative embodiment, polymer film 100 can be insert molded to the exterior surface of float 208. In another alternative embodiment as depicted in FIG. 12, polymer film 100 can be insert molded on the interior surface of sight tube 206. It will be obvious to one skilled in the art that the insert molding of a polymer film 100 could be applied just as effectively to flowmeters utilizing sensors to transmit fluid flow data. In such an embodiment, polymer film 100 could be insert molded to a sensor utilizing a paddle wheel, turbine, magnet or other flow sensing device commonly used in the semiconductor processing industry.

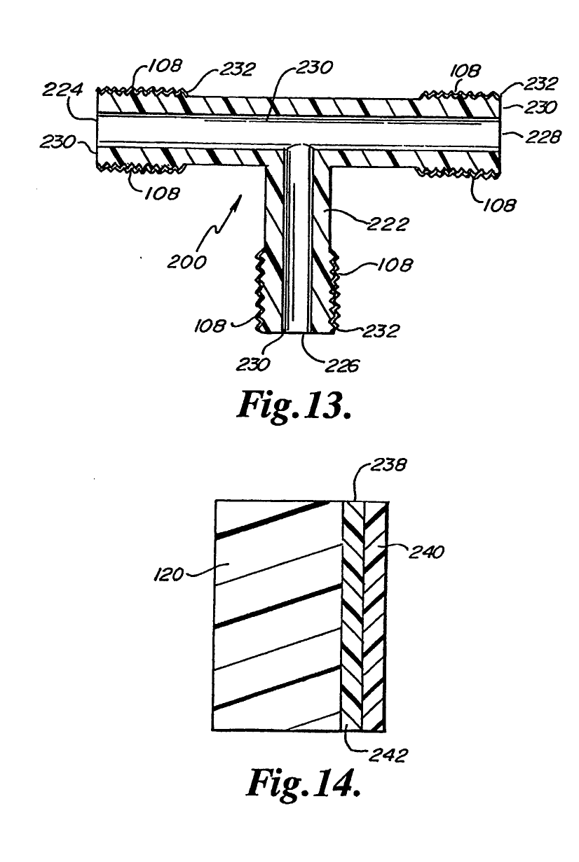

As depicted in FIG. 13, the fluid processing device 116 can be in the form of a tube connector 220. Tube connector 220 includes a connector body 222 including a first port 224, a second port 226 and a third port 228. Connector body 222 includes a continuous flow channel 230 linking first port 224, second port 226 and third port 228. Tube connector 220 is connected to a fluid circuit with the use of a male connection 230 including an exterior thread 232. Male connection 230 is present on first port 224, second port 226 and third port 228. In the present embodiment, polymer film 100 has been inserted molded over exterior threads 232. In an alternative embodiment, polymer film 100 can be insert molded on the interior wall of flow channel 230.

With respect to FIG. 13, it will be obvious to one skilled in the art that the insert molding of polymer film 100 can be applied to almost any tube connector configuration without departing from the spirit and scope of the present invention. These configurations could include any combination of ports, all variety of connections including male and female, threaded style connectors, compression fittings and, sanitary connectors.

In certain instances, the insert molded polymer film 100 may not adhere sufficiently to the target surface of the injected moldable material 112. For example, PEEK does not adhere in all cases to PC. Referring to FIG. 14, an multi-layer insert molded polymer film 238 comprises a first film layer 240 and a second film layer 242. Generally, first film layer 240 and second film layer 242 are inserted individually into molding unit 102 prior to injecting the moldable material 112. Alternatively, the first film layer 240 and second film layer 242 may be adhered to one another, such as by vacuum molding, thermal bonding, compression or otherwise, before insertion into molding unit 102. In some instances, second film layer 242 is used as an intermediate to promote bonding between first film layer 240 and injected moldable material 112. For example, it has been found that an intermediate film such as PEI adheres to both the PEEK and to PC. In alternative embodiments, first film layer 240 and second film layer 242 possess differing advantageous performance characteristics. For example, first film layer 240 may provide abrasion resistance while second film layer may have characteristics preventing offgasing. It will be obvious to one skilled in the art, that the use of multi-layer insert molded polymer film 238 is applicable to all the aforementioned embodiments in which polymer film 100 was used.

The present invention may be embodied in other specific forms without departing from the spirit or essential attributes thereof, and it is, therefore, desired that the present embodiments be considered in all respects as illustrative and not restrictive.

1. A fluid control device for use in semiconductor processing, comprising:
at least one thermoplastic component structure making up a part of the fluid processing device; and
at least one thin, flexible protective thermoplastic film securely adhered by insert molding along a portion of the thermoplastic component structure to provide containment characteristics to the fluid control device.

2. The device of claim 1, wherein the at least one thin, flexible protective thermoplastic film includes a film having containment characteristics selected from the group consisting of: abrasion resistance, chemical resistance, heat resistance, fluid absorption prevention, ultraviolet resistance, friction reduction, rigidity enhancement or outgassing prevention.

3. The device of claim 1, wherein the at least one thin, flexible protective thermoplastic film is constructed substantially of a material selected from the group consisting of: polyester, polyimide, polyether imide, polyetheretherketone, perfluoroalkoxy resin, fluorinated ethylene propylene copolymer, polyvinylidene fluoride, polymethyl methacrylate, polyether sulfone, polystyrene, and polyphenylene sulfide.

4. The device of claim 1, wherein the at least one thin, flexible protective thermoplastic film is constructed substantially of polyetheretherketone.

5. The device of claim 2, wherein the at least one thin, flexible protective thermoplastic film is a film laminate having at least two thin, flexible film layers.

6. The device of claim 5, wherein the at least two thin, flexible film layers each have different containment characteristics.

7. The device of claim 5, wherein at least one of the at least two thin, flexible film layers is an intermediate layer whereby the bond strength between the protective film and the at least one thermoplastic component structure is improved.

8. The device of claim 1, wherein the at least one thermoplastic component structure is a valve.

9. The device of claim 8, wherein the valve comprises a valve body and a valve stem.

10. (canceled).

11. The device of claim 9, wherein the at least one thin, flexible thermoplastic film is selectively adhered to a surface on the valve stem.

12. The device of claim 1, wherein the at least one thermoplastic component structure is a length of plastic tubing.

13. The device of claim 12, wherein the at least one thin, flexible thermoplastic film is selectively adhered to an interior surface of the plastic tubing.

14. The device of claim 12, wherein the at least one thin, flexible thermoplastic film is selectively adhered to an exterior surface of the plastic tubing.

15. The device of claim 14, wherein the exterior surface of the plastic tubing comprises a barbed end.

16. The device of claim 1, wherein the at least one thermoplastic component structure is a flowmeter.

17. The device of claim 16, wherein the flowmeter comprises a translucent sight tube, an inlet, an outlet and a float.

18. The device of claim 16, wherein the at least one thin, flexible thermoplastic film is selectively applied to an interior surface of the flowmeter.

19. The device of claim 16, wherein the at least one thin, flexible thermoplastic film is selectively applied to an exterior surface of the flowmeter.

20. The device of claim 1, wherein the at least one thermoplastic component structure is a plastic tubing connector.

21. The device of claim 20, wherein the plastic tubing connector comprises at least two fluid connections and a flow channel.

22. The device of claim 20, wherein the at least one thermoplastic film is selectively and securely adhered applied to an interior surface of the connector.

23. The device of claim 20, wherein the at least one thermoplastic film is selectively and securely adhered to an exterior surface of the connector.

24. A method of film insert molding a semiconductor fluid control component through meltably bonding at least one thin, flexible containment thermoplastic film to at least a portion of a thermoplastic material, comprising the steps of:
accessing a molding unit having a mold cavity, the mold cavity including at least one shaping surface;
positioning the at least one thin, flexible containment thermoplastic film within the cavity of the molding unit along at least a portion of the at least one shaping surface;
injecting a substantially molten thermoplastic material into the cavity of the molding unit to conform to the shape of the at least one shaping surface;
waiting a cooling period wherein the thermoplastic material substantially solidifies to matably bond with the at least one thin, flexible containment thermoplastic film to generate a protective containment surface on the semiconductor fluid processing component; and
ejecting the semiconductor fluid control component from the molding unit.

25. The method of claim 24, wherein the at least one thin, flexible containment thermoplastic film has a protective characteristic selected from the group consisting of: abrasion resistance, chemical resistance, heat resistance, fluid absorption prevention, ultraviolet resistance, friction reduction, or outgassing prevention.

26. The method of claim 24, wherein the at least one thin, flexible containment thermoplastic film is constructed substantially of a material selected from the group consisting of: polyester, polyimide, polyether imide, polyetheretherketone, perfluoroalkoxy resin, fluorinated ethylene propylene copolymer, polyvinylidene fluoride, polymethyl methacrylate, polyether sulfone, polystyrene, and polyphenylene sulfide.

27. The method of claim 24, wherein the at least one thin, flexible containment thermoplastic film is constructed substantially of polyetheretherketone.

28. The method of claim 24 wherein the semiconductor fluid control component is selected from the group consisting of: valves, tubing, flowmeters, manifolds, regulator and connectors.

29. The method of claim 24 wherein the semiconductor fluid control component is a subcomponent of the semiconductor fluid controlg component.

30. The method of claim 24, further comprising the step of thermoforming the at least one thin, flexible containment thermoplastic film.

31. The method of claim 30, wherein thermoforming the at least one thin, flexible containment thermoplastic film includes thermoforming a multi-layer film laminate wherein at least one of the film layers is a thin, flexible containment thermoplastic film.

32. The method of claim 31, wherein the multi-layer film laminate includes at least two film layers, wherein a first film layer has a containment characteristic different than a second film layer.

33. The method of claim 31, wherein the multi-layer film laminate includes an intermediate layer for improving bond strength between the thin, flexible containment thermoplastic film and the thermoplastic material.

34. A thermoplastic valve for use in semiconductor processing, comprising:
a valve body containing a plurality of fluid ports, said valve body including a central bore whereby the plurality of fluid ports are in fluid communication;
a valve stem, the valve stem including a handle, a rod and a sealing face, the valve stem being sealingly mounted within the central bore; and
at least one thin, flexible thermoplastic protective film, said film securely adhered along a portion of the valve by insert molding to impart a protective characteristic to the valve.

35. The valve of claim 34, wherein the at least one thin, flexible thermoplastic protective film imparts a protective characteristic selected from the group consisting of: abrasion resistance, chemical resistance, heat resistance, fluid absorption prevention, ultraviolet resistance, friction reduction, rigidity enhancement or outgassing prevention.

36. The valve of claim 34, wherein the at least one thin, flexible thermoplastic protective film is constructed substantially of a material selected from the group consisting of: polyester, polyimide, polyether imide, polyetheretherketone, perfluoroalkoxy resin, fluorinated ethylene propylene copolymer, polyvinylidene fluoride, polymethyl methacrylate, polyether sulfone, polystyrene, and polyphenylene sulfide.

37. The valve of claim 34, wherein the at least one thin, flexible thermoplastic protective film is constructed substantially of polyetheretherketone.

38. The valve of claim 34, wherein the thin, flexible protective film is insert molded to a portion of the valve body.

39. The valve of claim 34, wherein the thin, flexible protective film is insert molded to a portion of the valve stem.

40. The valve of claim 34, wherein the at least one thin, flexible protective thermoplastic film comprises a multi-layer film laminate.

41. The valve of claim 40, wherein the multi-layer film laminate includes a first film layer and a second film layer, wherein said first film layer has a protective characteristic different than the second film layer.

42. The valve of claim 40, wherein the multi-layer film laminate includes an intermediate layer for improving bond strength between the protective thermoplastic film and the thermoplastic material.

43. A length of tubing for use in semiconductor processing, comprising:
a thermoplastic tube having a distal end and a proximal end, said tube defining a flow channel whereby said distal end and proximal end are in fluid communication; and
at least one thin, flexible thermoplastic protective film, said film securely adhered along a portion of the tube by insert molding to impart a protective characteristic to the tube.

44. The tubing of claim 43, wherein the at least one thin, flexible thermoplastic protective film imparts a protective characteristic selected from the group consisting of: abrasion resistance, chemical resistance, heat resistance, fluid absorption prevention, ultraviolet resistance, friction reduction, rigidity enhancement or outgassing prevention.

45. The tubing of claim 43, wherein the at least one thin, flexible thermoplastic protective film is constructed substantially of a material selected from the group consisting of: polyester, polyimide, polyether imide, polyetheretherketone, perfluoroalkoxy resin, fluorinated ethylene propylene copolymer, polyvinylidene fluoride, polymethyl methacrylate, polyether sulfone, polystyrene, and polyphenylene sulfide.

46. The tubing of claim 43, wherein the at least one thin, flexible thermoplastic protective film is constructed substantially of polyetheretherketone.

47. The tubing of claim 43, wherein the proximal end includes a barb.

48. The tubing of claim 43, wherein the at least one protective thin, flexible thermoplastic film comprises a multi-layer film laminate.

49. The tubing of claim 48, wherein the multi-layer film laminate includes a first film layer and a second film layer, wherein said first film layer has a protective characteristic different than the second film layer.

50. The tubing of claim 48, wherein the multi-layer film laminate includes an intermediate layer for improving bond strength between the protective thermoplastic film and the thermoplastic material.

51. A flowmeter assembly for use in semiconductor processing, comprising:
a flowmeter including an inlet port and an outlet port, the flowmeter also including a flow indicator mounted between the inlet port and outlet port; and
at least one thermoplastic protective film, said film securely adhered along a portion of the flowmeter by insert molding to impart a protective characteristic to the flowmeter.

52. The flowmeter assembly of claim 51, wherein the at least one thin, flexible thermoplastic protective film imparts a protective characteristic selected from the group consisting of: abrasion resistance, chemical resistance, heat resistance, fluid absorption prevention, ultraviolet resistance, friction reduction, rigidity enhancement or outgassing prevention.

53. The flowmeter assembly of claim 51, wherein the at least one thin, flexible thermoplastic protective film is constructed substantially of a material selected from the group consisting of: polyester, polyimide, polyether imide, polyetheretherketone, perfluoroalkoxy resin, fluorinated ethylene propylene copolymer, polyvinylidene fluoride, polymethyl methacrylate, polyether sulfone, polystyrene, and polyphenylene sulfide.

54. The flowmeter assembly claim 51, wherein the at least one thin, flexible thermoplastic protective film is constructed substantially of polyetheretherketone.

55. The flowmeter assembly of claim 51, wherein the flow indicator comprises an opaque sightglass and a float.

56. The flowmeter assembly of claim 51, wherein the at least one thin, flexible protective thermoplastic film comprises a multi-layer film laminate.

57. The flowmeter assembly of claim 56, wherein the multi-layer film laminate includes a first film layer and a second film layer, wherein said first film layer has a protective characteristic different than the second film layer.

58. The flowmeter assembly of claim 56, wherein the multi-layer film laminate includes an intermediate layer for improving bond strength between the protective thermoplastic film and the thermoplastic material.

59. A connector for use in semiconductor processing, comprising:
a thermoplastic connector including a plurality of ports, and
at least one thin, flexible thermoplastic protective film, said film securely adhered along a portion of the connector by insert molding to impart a protective characteristic to the connector.

60. The connector of claim 59, wherein the at least one thin, flexible thermoplastic protective film imparts a protective characteristic selected from the group consisting of: abrasion resistance, chemical resistance, heat resistance, fluid absorption prevention, ultraviolet resistance, friction reduction, rigidity enhancement or outgassing prevention.

61. The connector of claim 59, wherein the at least one thin, flexible thermoplastic protective film is constructed substantially of a material selected from the group consisting of: polyester, polyimide, polyether imide, polyetheretherketone, perfluoroalkoxy resin, fluorinated ethylene propylene copolymer, polyvinylidene fluoride, polymethyl methacrylate, polyether sulfone, polystyrene, and polyphenylene sulfide.

62. The connector of claim 59, wherein the at least one thin, flexible thermoplastic protective film is constructed substantially of polyetheretherketone.

63. The connector of claim 59, wherein the at least one thin, flexible protective thermoplastic film comprises a multi-layer film laminate.

64. The connector of claim 63, wherein the multi-layer film laminate includes a first film layer and a second film layer, wherein said first film layer has a protective characteristic different than the second film layer.

65. The connector of claim 63, wherein the multi-layer film laminate includes an intermediate layer for improving bond strength between the protective thermoplastic film and the thermoplastic material.
